(19) United States
(12) Patent Application Publication
(10) Pub. No.: US 2004/0218272 A1
(43) Pub. Date: Nov. 4, 2004

(54) RESIZABLE MIRROR HEATING ELEMENT AND VEHICULAR MIRROR ASSEMBLY INCORPORATING THE SAME

(75) Inventor: Ian Boddy, Ada, MI (US)

Correspondence Address: MCGARRY BAIR PC, 171 MONROE AVENUE, N.W., SUITE 600, GRAND RAPIDS, MI, 49503, US

(73) Assignee: MAGNA DONNELLY MIRRORS NORTH AMERICA L.L.C., Kentwood, MI (US)

(21) Appl. No.: 10/604,372

(22) Filed: Jul. 15, 2003

Related U.S. Application Data
(60) Provisional application No. 60/319,398, filed on Jul. 15, 2002.

(51) Int. Cl. G02B 1/00; G02B 7/182

(52) U.S. Cl. 359/512; 359/871

(57) ABSTRACT

A vehicular mirror includes a heater is mounted adjacent to the mirror and is preferably resizable to conform to a configuration of the mirror. A method of manufacturing a vehicular mirror assembly is provided as well. An exemplary mirror according to the invention has a housing with an opening, a heater and a mirror. The heater is resized to conform with the size of the mirror. The heather element is mounted within the housing adjacent to the mirror. The resizable nature of the heater element allows a commonly-sized heater element to be used in a wide variety of mirror configurations, shapes and sizes.

### CROSS REFERENCE TO RELATED APPLICATIONS

This application claims the benefit of U.S. Provisional Application Serial No. 60/319,398, filed on Jul. 15, 2002.

### BACKGROUND OF INVENTION

1. Field of the Invention

In one aspect, the invention relates to a heater for a vehicular mirror assembly including a heater element that is resizable to conform to the size and/or shape of a mirror in the vehicular mirror assembly. In another aspect, the invention relates to a method of manufacturing a vehicular mirror with a heater element including the steps of resizing the heater element and mounting the heater element to the mirror.

2. Description of the Related Art

External mirrors are ubiquitous for contemporary vehicles and have long been used to aid the driver in operating the vehicle, especially in improving the rearward view of the driver. A typical rearview mirror comprises a housing having an opening and a mirror element mounted in the housing in register with the opening in the housing for rearward reflective viewing. Over time, more and more functionality has been incorporated into the external mirror assemblies. For example, it has become common to mount a heater element adjacent to the mirror within the housing to aid in deicing, defrosting, and defogging operations on the mirror surface.

The heater element has taken many forms over the years, but most recently as a “pad” which is mounted in planar alignment behind the mirror within the mirror housing. For example, ITW ChronoTherm has developed a heater pad for rear-view mirrors on passenger cars, trucks, and other vehicles that uses a proprietary material that is self-regulating in temperature control and allows for high wattage heating at sub-zero temperatures.

While the performance of heater elements such as the example provided in the previous paragraph has been satisfactory, the time, cost, and complexity of manufacturing vehicular mirrors with these heating elements can be extensive and costly mainly due to the wide variety of configurations, shapes, and sizes of vehicular mirrors. For example, a computer-based thermal analysis program has been used in the past to analyze each mirror shape and to determine the power distribution necessary to provide the most even temperature distribution. In addition, since each mirror shape can be unique, the heater element must typically be customized for each mirror design to take into account performance specifications, heat transfer conditions, process capabilities, and production tolerances. Often, computer aided design (CAD) files must be generated for each mirror shape.

### SUMMARY OF INVENTION

In one of its aspects, the invention relates to a vehicular mirror comprising: a housing adapted to be mounted to a vehicle body, the housing having an opening therein; a mirror mounted within the housing and having a reflective surface in register with the opening in the housing; a mounting plate in register with the mirror; and a heater element mounted adjacent to the mirror to the mounting plate within the housing, the heater element being sizable to conform to a size of a selected one of a plurality of mirrors.

In another of its aspects, the invention relates to a heater element for a vehicular mirror wherein: the heater element is selectively sizable to conform to a size of a selected one of a plurality of mirrors.

Various embodiments are contemplated within the broad scope of this invention. The heater element can be sized to conform to the perimeter of the selected one of the plurality of mirrors. The heater element can be stretched to conform to the size of the selected one of the plurality of mirrors. The heater element can further comprise at least one row of spaced-apart penetrations and the penetrations form apertures when the heater element is stretched. The penetrations can be slits. The slits can be parallel to each other. The slits can be inclined relative to each other. The at least one row of spaced-apart penetrations can comprise at least two rows of spaced-apart penetrations. The penetrations in a first row of the at least two rows of spaced-apart penetrations can be spaced laterally from the penetrations in a second row of the at least two rows of spaced-apart penetrations. The heater element can be wrapped around at least one edge of the mounting plate.

A bezel can be provided wherein the heater element is attached to the mounting plate by the bezel which applies a clamping force to the heater element where the heater element is wrapped around the at least one edge of the mounting plate. The heater element can further comprise a roll-formed seam along at least one edge wherein the heater element is attached to the mounting plate by the roll-formed seam which is retained against the mounting plate when the heater element is wrapped around the at least one edge of the mounting plate. The heater element can be an elliptical spiral and an end portion of the elliptical spiral can be removed to conform the heater element to the size of the selected one of the plurality of mirrors. The heater element can be an elliptical spiral and the elliptical spiral can be stretched to conform the heater element to the size of the selected one of the plurality of mirrors.

In another aspect, the invention relates to a method of manufacturing a vehicular mirror assembly comprising a mirror housing having an opening, a heater element, a mounting plate, and a selected one of a plurality of various-sized mirrors, the method comprising the steps of: selectively sizing the heater element to conform with the size of the selected one of the plurality of various-sized mirrors; and mounting the heater element within the housing adjacent to the mirror.

The method can further comprise the step of forming slits in the heater element. The slits can be parallel to each other. The slits can be inclined relative to each other. The method can further comprise the step of stretching the heater element to conform to the size of the selected one of the plurality of various-sized mirrors. The method can further comprise the step of wrapping the heater element around at least one edge of the mounting plate. The method can further comprise the step of attaching a bezel to the mounting plate after the heater element is wrapped around the at least one edge of the mounting plate so that the bezel applies a clamping force to the heater element where the heater element is wrapped around the at least one edge of the mounting plate. The method can further comprise the step of forming a roll-formed seam along at least one edge of the heater element. The method can further comprise the step of attaching the heater element to the mounting plate so that the heater element is attached to the mounting plate by the roll-formed seam which is retained against the mounting plate when the heater element is wrapped around the at least one edge of the mounting plate. The method can further comprise the step of forming the heater element as an elliptical spiral. The method can further comprise the step of removing an end portion of the elliptical spiral to conform the heater element to the size of the selected one of the plurality of mirrors. The method can further comprise the step of stretching the elliptical spiral to conform the heater element to the size of the selected one of the plurality of mirrors.

### BRIEF DESCRIPTION OF DRAWINGS

FIG. 1 is a perspective view of a vehicular mirror assembly according to the invention.

FIG. 2 is an exploded perspective view of the vehicular mirror assembly of FIG. 1 with a mirror removed to expose a resizable heater element according to the invention.

FIG. 3 is a top plan view of the heater element of FIG. 2 in a sized configuration for the mirror assembly of FIG. 1.

FIG. 4 is a top plan view of the heater element of FIG. 2 in an unsized configuration.

FIG. 5 shows the unsized heater element of FIGS. 2-4 being stretched in a first direction.

FIG. 6 shows the unsized heater element of FIGS. 2-4 being stretched in a second direction.

FIG. 7 shows the unsized heater element of FIGS. 2-4 being stretched in the first and second directions generally simultaneously.

FIG. 8 shows a first alternative embodiment of the heater element of FIGS. 2-7.

FIG. 9 shows a second alternative embodiment of the heater element of FIGS. 2-7.

FIG. 10 shows a mirror housing being sized to receive a sizeable mirror heating element according to the invention by way of determination of the major and minor axes of the mirror assembly.

FIG. 11 shows the mirror housing of FIG. 10 receiving the heating element of FIG. 9.

FIG. 12 shows a third alternative embodiment of the heater element of FIGS. 2-7.

FIG. 13 shows a fourth alternative embodiment of the heater element of FIGS. 2-7 in an exploded configuration with a mirror element on which it is to be mounted.

FIG. 14 is a cross-section taken along lines 14-14 of FIG. 13.

FIG. 15 shows a fifth alternative embodiment of the heater element of FIGS. 2-7.

### DETAILED DESCRIPTION

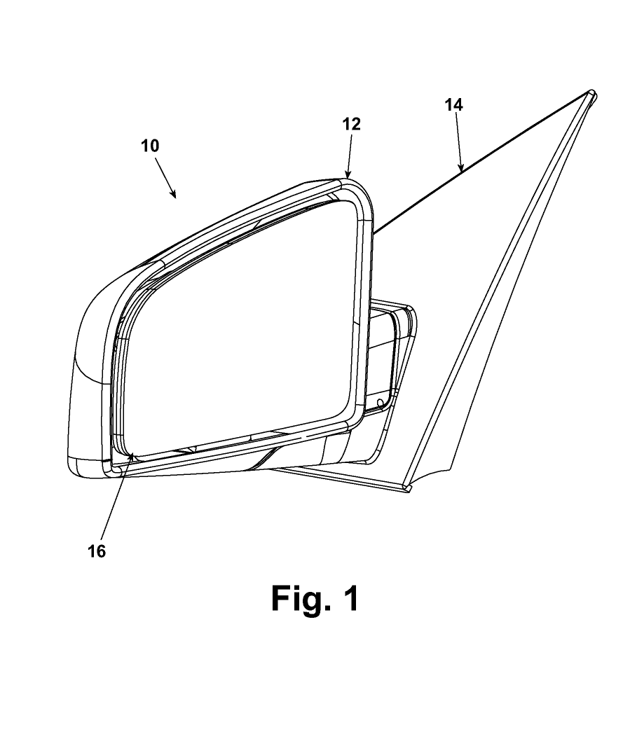

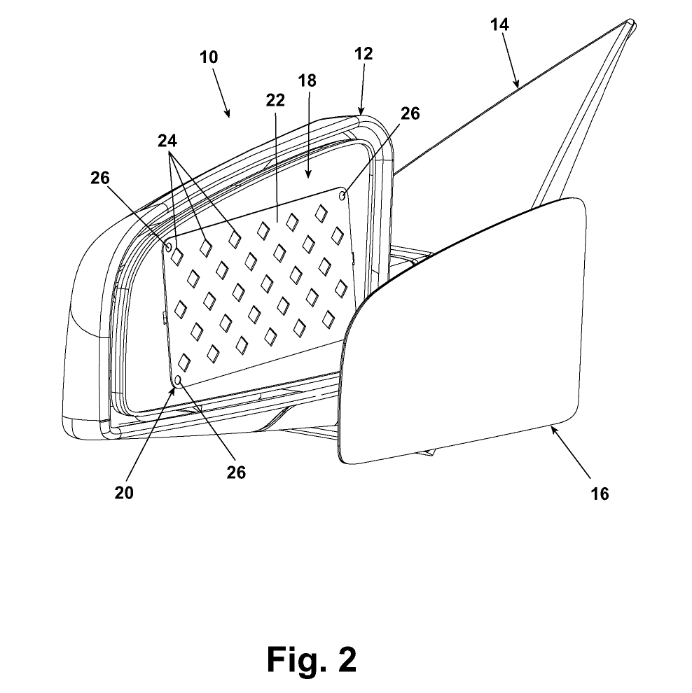

Referring now to the drawings and to FIGS. 1-2 in particular, a vehicular mirror assembly 10 is shown comprising a housing 12 that is adapted to be mounted to a vehicle (not shown), such as by a mounting to a base 14. A mirror 16 is mounted within the housing 12 in a conventional manner.

It will be understood that the mirror assembly 10 shown and described herein is for illustrative purposes only and can take the form of any well-known mirror assembly. The mirror assembly 10 can also include various functional items including, but not limited to, a manually-or powered-folding device for pivoting the mirror housing relative to a vehicle, a manually- or powered-extension device for extending the mirror housing relative to a vehicle, and/or a manually- or powered-actuation device for pivoting the mirror relative to the mirror housing.

As can be seen in FIG. 2, the mirror 16 is mounted to a mounting plate 18 with a heater element 20 therebetween. Although its configuration is not important to this invention, the mounting plate 18 is typically a planar member that is interconnected to the housing via a gimbal joint (not shown) on its forward-facing side to allow for pivotal movement of the mirror 16 with respect to the housing 12. As is commonly-known in the art, the mounting plate 18 can also receive powered actuators for pivotally adjusting the mirror 16 relative to the housing 12 by way of a hand-switch carried onboard the vehicle (not shown) which effectuates pivotal adjustment of the mirror 16.

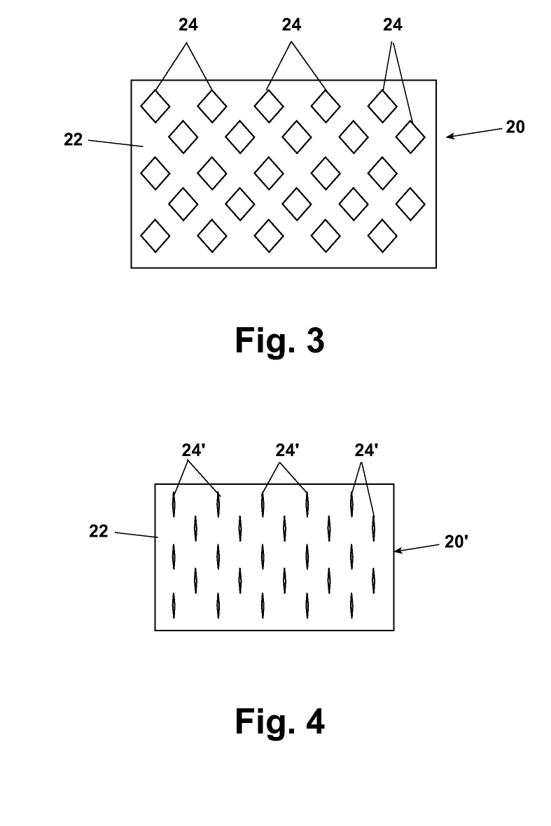

The heater element 20 is the focus of this invention and comprises a body 22, generally planar in configuration, which is mounted between the mirror 16 and the mounting plate 18 within the mirror housing 12. The body 22 of the heater element 20 has several apertures therein, shown by example by reference numeral 24 in FIG. 3.

The heater element 20 is resizable so that the heater element 20 can be manufactured in a common size and stretched at the time of assembly to the mounting plate 18. For example, an unsized configuration 20′ of the heater element 20 is shown in FIG. 4 comprising several penetrations or slits 24′ formed in the body 22 of the unsized sized heater element 20′. Preferably, the slits 24′ are arranged in a predetermined pattern to provide an optimal level of stretchability to the unsized heater element 20′, although any configuration and arrangement of the slits 24′ may be used without departing from the scope of this invention.

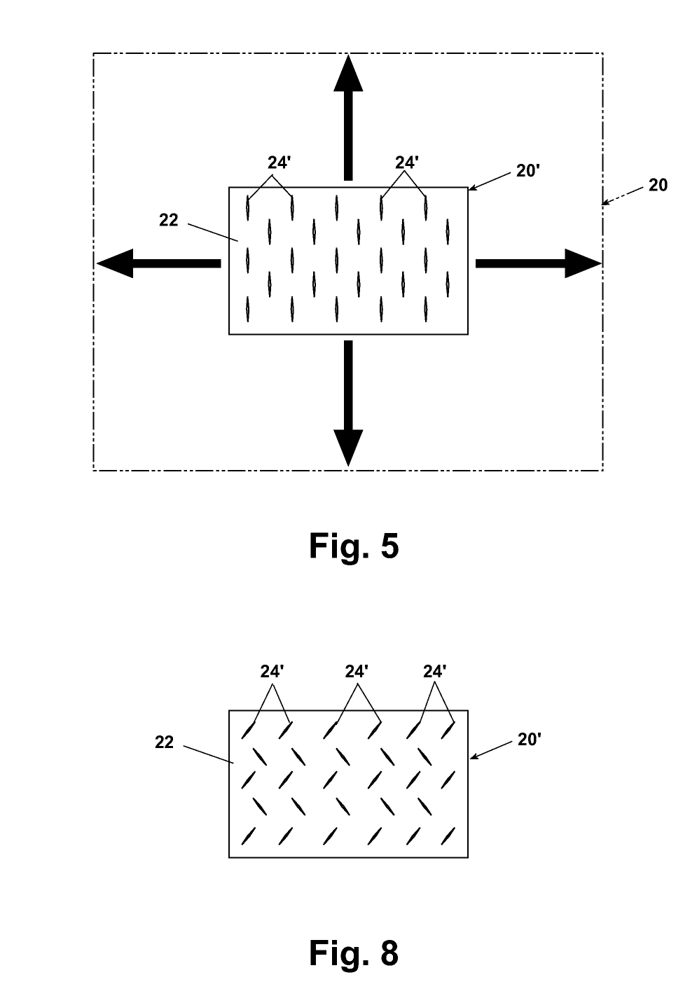

For example, it has been found that the row-by-row off-set arrangement shown in FIG. 4 produces preferable results. In FIG. 4, it can be seen that the horizontal positioning of the slits 24′ in one row is out of phase with the horizontal positioning of the slits 24′ in immediately adjacent rows. In this manner, as the unsized heater element 20′ is stretched in the horizontal and vertical directions shown in FIG. 5, the slits 24′ form the apertures 24 as shown in FIG. 3 throughout the body 22 of the sized heater element 20 of FIG. 3. The offset arrangement of the slits 24′ aligns sufficiently large portions of the material making up the body 22 with ends of the slits 24′ to prevent tearing during resizing of the heater element 20.

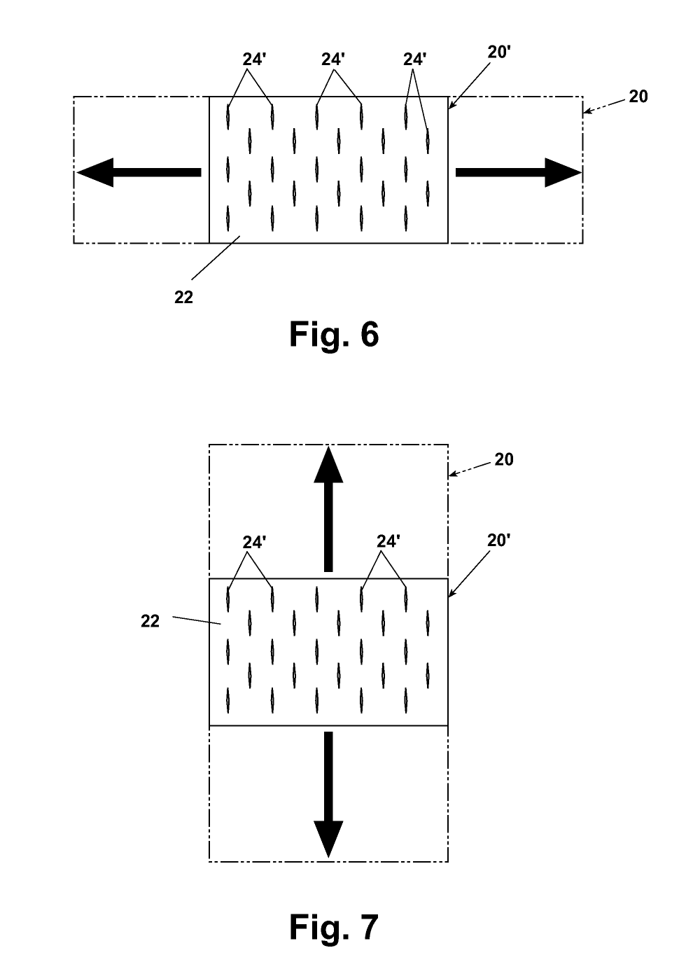

FIGS. 6 and 7 show the unsized heater element 20′ of FIG. 4 being stretched only in a single direction, i.e., horizontally in FIG. 6 and vertically in FIG. 7. In addition, FIG. 8 shows an alternative arrangement of the slits 24′ in the body 22 of the unsized heater element 20′ for producing a different pattern of apertures 24 once the heater element is placed into a sized configuration (i.e., identified by reference numeral 20 in the example sized configuration in FIG. 3).

In assembly, the unsized heater element 20′ as shown in FIG. 4 is stretched at the time of assembly to the mounting plate 18 into the larger configuration shown in FIG. 3 in which the slits 24′ are converted into the apertures 24 as a result of the resizing of the heater element from the unsized configuration 20′ (see FIG. 4) to the sized configuration 20 (see FIG. 3). The sized configuration of the heater element can be mounted to the mounting plate 18 in any conventional manner such as heat stakes 26 shown at each corner of the heater element 20 in FIG. 2. The heater element 20 is interconnected to a selectively actuated source of electricity to provide the power necessary to activate the heater element 20 during use to provide a source of heat to the mirror 16.

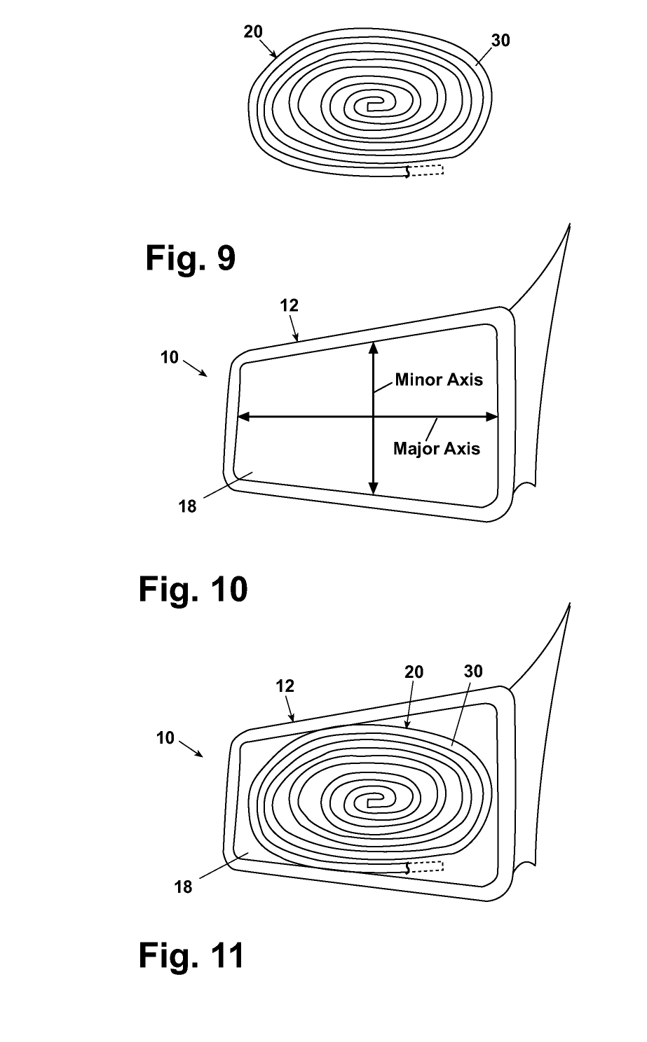

FIG. 9 shows a second alternative embodiment of the heater element of FIGS. 2-7. In this embodiment, the heater element 20 is provided as an elliptical configuration having a major and a minor axis as is conventionally known in the geometry of ellipses. More specifically, the embodiment of the heater element 20 in FIG. 9 is shown as a spiral member 30 increasing radially outwardly in expansion. With reference to FIG. 10, a major and a minor axis of a mirror housing 12 (and its associated mirror mounting plate 18) can be identified. Then, as shown in FIG. 11, the spiral member 30 of the heating element 20 shown in FIG. 9 can be “snipped” at a location so that the major and minor axes of the resulting elliptical configuration of the heater element 20 in FIG. 9 generally corresponds to the major and minor axes of the mounting plate 18 and, thus, the mirror element 16. Of course, the spiral member 30 can be stretched as it is applied for greater coverage with respect to the mirror element 16. In this manner, the spiral member 30 is sizeable to provide an optimal degree of coverage to the mounting plate 18.

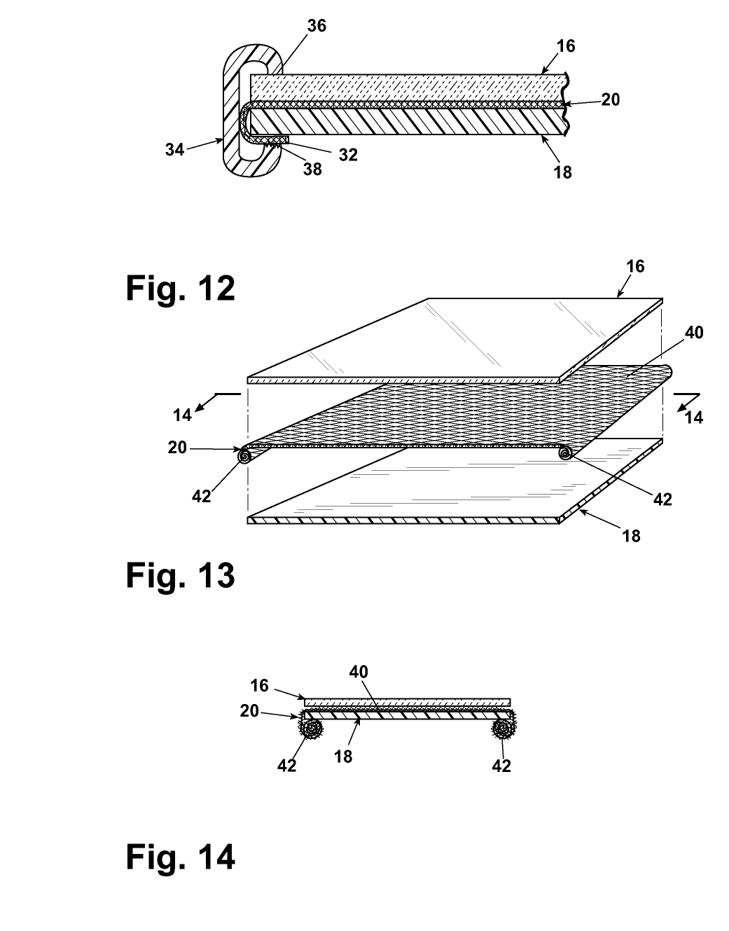

FIG. 12 shows a third alternative embodiment of the heater element of FIGS. 2-7. In this manner, the heater element 20 of FIG. 12 is shown disposed between the mirror element 16 and the mounting plate 18 as previously described. However, in this embodiment, the heater element 20 is stretched across the face of the mounting plate 18 and wrapped around its periphery, a portion of which is shown in FIG. 12. A terminal end 32 of the heater element 20 is held in place by a bezel 34 which is shown as a C-shaped member with a first end 36 abutting a surface of the mirror element 16 and a second end 38 (shown with an optional serrated surface) pinching the periphery of the heater element 30 between the second end 38 of the bezel 34 and an underside of the mounting plate 18.

FIG. 13 shows a fourth alternative embodiment of the heater element of FIGS. 2-7 in an exploded configuration with a mirror element 16 and a mounting plate 18 on which it is to be mounted. The heater element 20 of FIG. 13 is configured as a stretchable swatch of material 40 formed with reverse roll-formed seams 42 on at least two edges thereof. In the cross-section shown in FIG. 14, the seams 42 are stretched around the periphery of the mounting plate 18 and are retained therebehind, preferably due to the elastic nature of the material making up the heater element 20 in this embodiment.

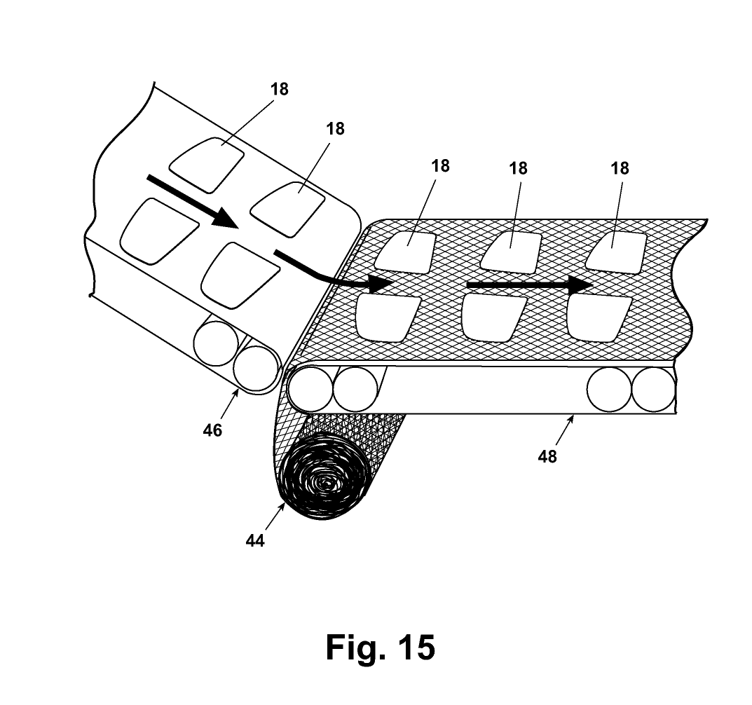

FIG. 15 shows a fifth alternative embodiment of the heater element of FIGS. 2-7. In this embodiment, the heater element 20 is shown as a web 44 of material traveling along a first conveyor 48 which is aligned with a second conveyor 46 carrying pre-formed mounting plates 18. The mounting plates 18 are delivered onto the web 44 from the conveyor 46 at which time the material making up the web 44 can be sized to the perimeter of the mounting plates 18 and separated from the web 44 to form the heater elements 20 for each of the mounting plates 18 in this process. The heater elements 20 can be affixed to the mounting plates 18 as previously described or through conventional means such as an adhesive, followed by attachment of the mirror 16 over the heater element 20. Alternatively, the heater elements 20 can be die cut from the material making up the web 44 in preselected shapes to be later stretched to fit a selected mounting plate 18 for assembly between the mounting plate 18 and the mirror 16 as described herein.

In any of the embodiments described herein, it will be understood that the material making up the heater element 20 can be any suitable material for delivering heat to the mirror element 16 and which is connected to a suitable power supply. The material making up the heater element 20 can include, but is not limited to: a conductive elastomer, a textile material (such as an open-weave gauze) having a carbon-based mesh material interweaved there-with, an elastomer with a carbon coating, an elastomeric material with a carbon material spray-coated thereon, a stretchable fabric material as a carrier with a sprayed-on conductive carbon ink, or a stretchable fabric with an applied adhesive (to aid bonding to the mounting plate 18) with an embedded carbon ink. It will be understood that other materials can also be employed without departing from the scope of this invention.

It has thereby been found that, with a heater element configuration 20 as shown herein, a commonly-sized unsized heater configuration can be made which is not dependent upon the size of the particular mirror assembly components (i.e., the mounting plate 18, the mirror 16, etc.). Rather, a far smaller subset of sizes of heater elements 20 can be provided and the heater elements 20 can be sized to a predetermined width and height of the mounting plate 18 at the time of manufacture. In this way, the novel heater element described herein provides great flexibility and cost savings in the manufacture of mirror assemblies 10.

While the invention has been specifically described in connection with certain specific embodiments thereof, it is to be understood that this is by way of illustration and not of limitation, and the scope of the appended claims should be construed as broadly as the prior art will permit.

1. A vehicular mirror comprising:
a housing adapted to be mounted to a vehicle body, the housing having an opening therein;
a mirror mounted within the housing and having a reflective surface in register with the opening in the housing;
a mounting plate in register with the mirror; and
a heater element mounted adjacent to the mirror to the mounting plate within the housing, the heater element being sizable to conform to a size of a selected one of a plurality of mirrors.

2. The vehicular mirror of claim 1 wherein the heater element is sized to conform to the perimeter of the selected one of the plurality of mirrors.

3. The vehicular mirror of claim 1 wherein the heater element is stretched to conform to the size of the selected one of the plurality of mirrors.

4. The vehicular mirror of claim 1 wherein the heater element further comprises at least one row of spaced-apart penetrations and the penetrations form apertures when the heater element is stretched.

5. The vehicular mirror of claim 4 wherein the penetrations are slits.

6. The vehicular mirror of claim 5 wherein the slits are parallel to each other.

7. The vehicular mirror of claim 5 wherein the slits are inclined relative to each other.

8. The vehicular mirror of claim 1 wherein the at least one row of spaced-apart penetrations comprises at least two rows of spaced-apart penetrations.

9. The vehicular mirror of claim 8 wherein the penetrations in a first row of the at least two rows of spaced-apart penetrations are spaced laterally from the penetrations in a second row of the at least two rows of spaced-apart penetrations.

10. The vehicular mirror of claim 1 wherein the heater element is wrapped around at least one edge of the mounting plate.

11. The vehicular mirror of claim 10 and further comprising a bezel wherein the heater element is attached to the mounting plate by the bezel which applies a clamping force to the heater element where the heater element is wrapped around the at least one edge of the mounting plate.

12. The vehicular mirror of claim 10 wherein the heater element further comprises a roll-formed seam along at least one edge wherein the heater element is attached to the mounting plate by the roll-formed seam which is retained against the mounting plate when the heater element is wrapped around the at least one edge of the mounting plate.

13. The vehicular mirror of claim 1 wherein the heater element is an elliptical spiral and an end portion of the elliptical spiral can be removed to conform the heater element to the size of the selected one of the plurality of mirrors.

14. The vehicular mirror of claim 1 wherein the heater element is an elliptical spiral and the elliptical spiral is stretched to conform the heater element to the size of the selected one of the plurality of mirrors.

15. A heater element for a vehicular mirror wherein:
the heater element is selectively sizable to conform to a size of a selected one of a plurality of mirrors.

16. The heater element of claim 15 wherein the heater element is sized to conform to the perimeter of the selected one of the plurality of mirrors.

17. The heater element of claim 15 wherein the heater element is stretched to conform to the size of the selected one of the plurality of mirrors.

18. The heater element of claim 15 wherein the heater element further comprises at least one row of spaced-apart penetrations and the penetrations form apertures when the heater element is stretched.

19. The heater element of claim 18 wherein the penetrations are slits.

20. The heater element of claim 19 wherein the slits are parallel to each other.

21. The heater element of claim 19 wherein the slits are inclined relative to each other.

22. The heater element of claim 15 wherein the at least one row of spaced-apart penetrations comprises at least two rows of spaced-apart penetrations.

23. The heater element of claim 8 wherein the penetrations in a first row of the at least two rows of spaced-apart penetrations are spaced laterally from the penetrations in a second row of the at least two rows of spaced-apart penetrations.

24. The heater element of claim 15 and further comprising a mounting plate wherein the heater element is wrapped around at least one edge of the mounting plate.

25. The heater element of claim 24 and further comprising a bezel wherein the heater element is attached to the mounting plate by the bezel which applies a clamping force to the heater element where the heater element is wrapped around the at least one edge of the mounting plate.

26. The heater element of claim 24 wherein the heater element further comprises a roll-formed seam along at least one edge wherein the heater element is attached to the mounting plate by the roll-formed seam which is retained against the mounting plate when the heater element is wrapped around the at least one edge of the mounting plate.

27. The heater element of claim 15 wherein the heater element is an elliptical spiral and an end portion of the elliptical spiral is removed to conform the heater element to the size of the selected one of the plurality of mirrors.

28. The heater element of claim 15 wherein the heater element is an elliptical spiral and the elliptical spiral is stretched to conform the heater element to the size of the selected one of the plurality of mirrors.

29. A method of manufacturing a vehicular mirror assembly comprising a mirror housing having an opening, a heater element, a mounting plate, and a selected one of a plurality of various-sized mirrors, the method comprising the steps of:
selectively sizing the heater element to conform with the size of the selected one of the plurality of various-sized mirrors; and
mounting the heater element within the housing adjacent to the mirror.

30. The method of claim 29 and further comprising the step of forming slits in the heater element.

31. The method of claim 30 wherein the slits are parallel to each other.

32. The method of claim 30 wherein the slits are inclined relative to each other.

33. The method of claim 29 and further comprising the step of stretching the heater element to conform with the size of the selected one of the plurality of various-sized mirrors.

34. The method of claim 29 and further comprising the step of wrapping the heater element around at least one edge of the mounting plate.

35. The method of claim 34 and further comprising the step of attaching a bezel to the mounting plate after the heater element is wrapped around the at least one edge of the mounting plate so that the bezel applies a clamping force to the heater element where the heater element is wrapped around the at least one edge of the mounting plate.

36. The method of claim 34 and further comprising the step of forming a roll-formed seam along at least one edge of the heater element.

37. The method of claim 36 and further comprising the step of attaching the heater element to the mounting plate so that the heater element is attached to the mounting plate by the roll-formed seam which is retained against the mounting plate when the heater element is wrapped around the at least one edge of the mounting plate.

38. The method of claim 29 and further comprising the step of forming the heater element as an elliptical spiral.

39. The method of claim 38 and further comprising the step of removing an end portion of the elliptical spiral to conform the heater element to the size of the selected one of the plurality of mirrors.

40. The method of claim 38 and further comprising the step of stretching the elliptical spiral to conform the heater element to the size of the selected one of the plurality of mirrors.
